(19) United States
(12) Patent Application Publication
(10) Pub. No.: US 2026/0276110 A1
(43) Pub. Date: Sep. 17, 2026

(54) High Density Polyethylene and Basalt Powder Composition and Methods Related Thereto

(71) Applicant: National Industrialization Company (TASNEE), Riyadh (SA)

(72) Inventors: Hafid Boufersaoui, Al-Jubail Industial City (SA); Omar S. Al Jebreen, Al-Jubail Industrial City (SA); Sulaiman S. Al-Khattaf, Al-Jubail Industrial City (SA)

(21) Appl. No.: 19/565,222

(22) Filed: Mar. 12, 2026

Related U.S. Application Data
(60) Provisional application No. 63/770,677, filed on Mar. 12, 2025.

(51) Int. Cl. F16L 9/12; B29B 9/12; B29C 48/13; B29K 23/00; B29K 105/16; B29K 303/08; C08K 3/26; C08K 9/06; C08L 23/06

(52) U.S. Cl. CPC F16L 9/12; B29B 9/12; B29C 48/13; C08K 3/26; C08K 9/06; C08L 23/06; B29K 2023/065; B29K 2023/08; B29K 2105/16; B29K 2303/08; C08K 2003/265; C08L 2205/02; C08L 2207/062

(57) ABSTRACT

The present disclosure provides a polymer blend composition, and non-pressure pipes produced therefrom, comprising high density polyethylene and basalt powder coated with methacryloxy functional trimethoxy silane.

### CROSS REFERENCE TO RELATED APPLICATIONS

This application claims benefit under 35 USC § 119(e) of U.S. Provisional Patent Application No. 63/770,677, filed Mar. 12, 2025. The entire contents of each of the above-referenced patent application(s) are hereby expressly incorporated by reference.

### BACKGROUND OF THE DISCLOSURE

Corrugated pipes are widely used in sewage and other drainage systems. A common material used to manufacture corrugated and non-pressure pipes is polyethylene. The lack of branches in polyethylene's structure allows the polymer chains to pack closely together resulting in a dense, highly crystalline material of high strength. However, the resulting material generally exhibits only moderate stiffness.

Currently, special fillers are added to the polyethylene matrix to enhance its stiffness. Examples of fillers added to polyethylene compositions for use in the manufacture of non-pressure pipes include calcium carbonate and talcum.

The present disclosure is related to a new material formulation for manufacturing single and double wall corrugated and non-corrugated high-density polyethylene (“HDPE”) pipes comprising an inorganic rigid filler such as basalt treated powder.

The following disclosure generally relates to an HDPE composition, a method of producing an HDPE composition, and an HDPE material formulation having increased stiffness, improved heat transfer, increased production rates, resistance to chemical products, enhanced chemical stability, and reduced cost. In some embodiments, a polymer blend of the present invention comprises HDPE and basalt powder coated with methacryloxy functional trimethoxy silane. In an illustrative example, the polymer blend composition comprises a blend of HDPE and coated basalt powder having a mass concentration in the range of about 5% to about 25%.

In one embodiment, the basalt powder is present as an additive in the HDPE compound in an amount in a range of 10% to 25% by weight.

In another embodiment, primary and secondary antioxidants are added to the polymer blend for stability.

In one embodiment, the basalt powder is coated with an amount in the range of from about 1% to 2% by weight of methacryloxy functional trimethoxy silane using a method comprising: diluting the methacryloxy functional trimethoxy silane in demineralized water; mixing the basalt powder and the diluted methacryloxy functional trimethoxy silane solution; and drying the basalt powder and methacryloxy functional trimethoxy silane solution for at least twelve hours at a temperature of substantially 100° C.

A method of the present invention comprises making a polymer blend, wherein the method comprises diluting methacryloxy functional trimethoxy silane in demineralized water; mixing basalt powder and the diluted methacryloxy functional trimethoxy silane; drying the basalt powder and methacryloxy functional trimethoxy silane mixture for at least twelve hours at a temperature of substantially 100° C. to obtain a coated basalt powder; mixing the coated basalt powder and HDPE powder to form a polymer blend mixture; extruding the polymer blend mixture; cooling the extruded polymer blend mixture; and pelletizing the cooled extruded polymer blend mixture into polymer blend pellets. One embodiment of the present invention is a method in which the polymer blend pellets are converted into corrugated non-pressure pipe.

### BRIEF DESCRIPTION OF THE DRAWINGS

The accompanying drawings, which are incorporated in and constitute a part of this specification, illustrate one or more implementations or testing equipment described herein and, together with the description, explain these implementations. Not every component may be labeled in every drawing. In the drawings:

FIGS. 1A and 1B are scanning electron microscope micrographs comparing untreated basalt powder (FIG. 1A) to treated basalt powder (FIG. 1B).

FIG. 2 is a graph comparing the effects of basalt powder content on enthalpy of crystallization observed between compounds containing different percentages of basalt powder.

FIG. 3 is a graph comparing specific heat capacities of different compounds including pure HDPE, HDPE plus 10% calcium carbonate, HDPE plus 20% calcium carbonate, HDPE plus 10% basalt powder, and HDPE plus 20% basalt powder.

FIG. 4 is an exemplary method of preparing a polymer compound comprising treated basalt powder and HDPE in accordance with at least one implementation of the present disclosure.

FIG. 5 is a cross-sectional rendering of corrugated pipe made in accordance with at least one implementation of the present disclosure.

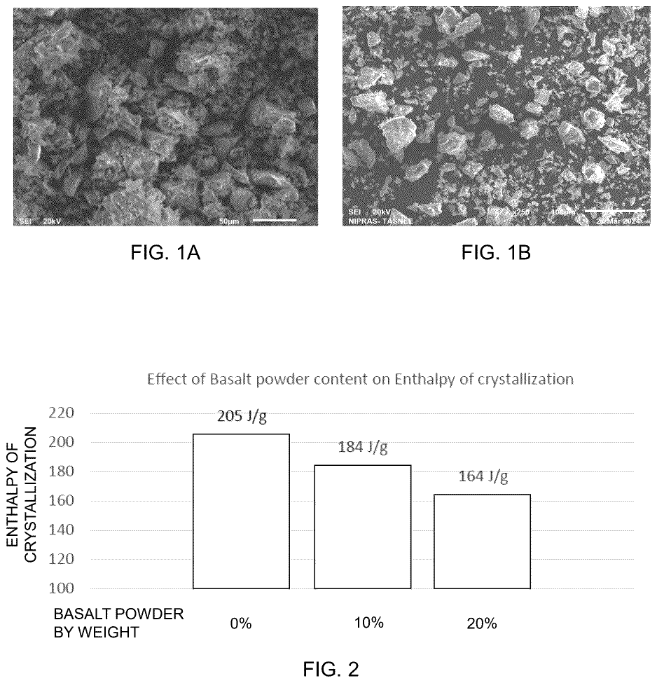

### DETAILED DESCRIPTION OF EXEMPLARY EMBODIMENTS

Before explaining at least one implementation of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the present disclosure have been described in terms of preferred embodiments, it will be apparent to those skilled in the art that variations may be applied to the articles and/or methods and in the steps or in the sequence of steps of the method described herein without departing from the concept and scope of the present disclosure. All such similar substitutes and modifications apparent to those skilled in the art are deemed to be within the scope and concept of the present disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

The term “polymer” as used herein refers to a polymeric compound prepared by polymerizing monomers, whether of the same or a different type.

The term “multimodal” as used herein refers to compositions that can be characterized by having multiple polymer subcomponents with varying densities and weight averaged molecular weights. For example, multimodal HDPE is characterized by multiple peaks on a molecular weight distribution curve. The multiple peaks demonstrate that the HDPE contains polymer chains of significantly different lengths. The term “multimodal” encompasses bimodal compositions, trimodal compositions, and compositions with weight distribution curves having more than three peaks.

In accordance with embodiments of the presently disclosed inventive concepts, basalt powder can be used as a filler in an HDPE compound to enhance stiffness, increase production rate, and ensure the stability in contact with chemicals flowing through non-pressure pipes.

The HDPE used in the compositions and methods of the present invention may comprise a homopolymer or copolymer multimodal HDPE. Some embodiments of the present invention comprise HDPE having a melt flow rate (MFR) in a range of about 0.20 g/10 min. to about 2.5 g/10 min at 5 kg and a temperature of 190° C. in accordance with test method ISO 1133. In at least one embodiment of the present invention, the HDPE has a density in the range of 0.950 g/cm³ to 0.960 g/cm³ according to test method ISO 1183.

In at least one embodiment of the present invention, using basalt powder as a filler in an HDPE compound in an amount in a range from about 5% to about 25% by weight enhances the performance of non-pressure pipes by, for instance, adding stiffness and thermal energy savings. During production of corrugated pipes, the presently disclosed compound of HDPE and basalt powder will improve heat transfer between the molten material parison and cooling block system of the equipment, thereby resulting in a higher production rate. Additionally, basalt is a stable and chemically inert additive that has a low cost when compared to current HDPE fillers which will reduce the overall cost of pipes.

Basalt powder is obtained through the processing of basalt, a dark-colored, fine-grained, igneous (volcanic) rock composed mainly of plagioclase and pyroxene minerals. In some embodiments, the basalt powder's surface is treated to improve its performance as an HDPE filler. Surface treatment of the basalt powder increases the dispersion of the filler in the HDPE compound and avoids creating areas of high and low filler concentrations in the compound as untreated basalt powder tends to agglomerate in the polymer as it melts.

In some embodiments of the present invention, the surface treatment of basalt powder may include coating the surface of the basalt powder with methacryloxy functional trimethoxy silane to improve a smoothness the surface of the basalt powder to reduce a coefficient of friction. This coating creates chemical bonds between inorganic phase basalt powder and the organic polymer matrix of HDPE.

The chemical composition of a basalt powder for use in an embodiment of the present invention is shown in Table 1. The minerals in basalt powder accelerate cooling by transferring heat from material melt to mold blocks of the production line. This increased heat transfer allows an increase in production rate and energy savings. Faster cooling increases pipe quality and socket profile forming by reducing sagging phenomena.

TABLE 1
CompositionofBasalt Powder

| No | Oxides | Units | Content |
|---|---|---|---|
| 1 | Na₂0 | % | 3.05 |
| 2 | MgO | % | 7.76 |
| 3 | Al₂O₃ | % | 13.5 |
| 4 | SiO₂ | % | 41.54 |
| 5 | P₂O₅ | % | 0.58 |
| 6 | SO₃ | % | 0.06 |
| 7 | K₂O | % | 1.59 |
| 8 | CaO | % | 11.35 |
| 9 | TiO₂ | % | 2.71 |
| 10 | V₂O₅ | % | 0 |
| 11 | Cr₂O₃ | % | 0.077 |
| 12 | Fe₂O₃ | % | 13.93 |
| 13 | Br | % | 3.39 |
| | Totalaccounted | % | 99.537 |

As will be described further herein, the improvement of stiffness of pipes made using the HDPE and basalt powder composition described herein results in a significant increase of flexural modulus of 1530 MPa, or more than around 27% compared to neat HDPE.

Basalt composition is chemically inert and stable, unlike calcium carbonate. Basalt has important properties, such as non-flammability, non-reactive chemically, high temperature resistance (900° C.), durable, and resistant to mechanical stress. Basalt is an eco-friendly material that is non-toxic to humans and animals. Due to these unique properties, the basalt powder can be applied in various fields of engineering and technology including manufacturing of sewage and drainage single and double wall corrugated pipes.

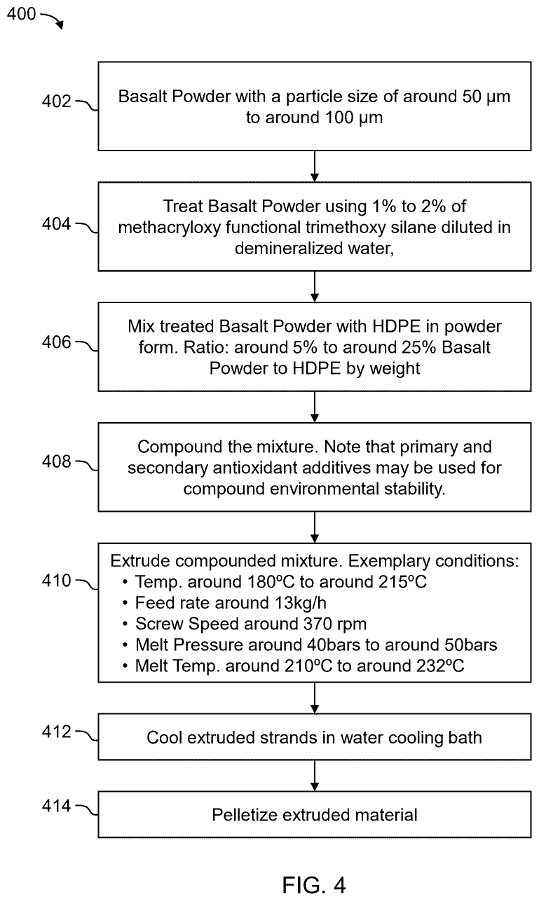

Referring now to FIG. 4, shown therein is a method 400 of creating a coupling of filler to polymer matrix, i.e., chemical bonds between inorganic phase basalt powder and organic polymer matrix HDPE.

In step 402, basalt powder is obtained. In some embodiments, basalt rock may be crushed, milled or ground, screened to obtain a desired particle size, dried, and packaged. In at least one implementation, a basalt powder having a particle size in a range of between 50 μm to 100 μm may be used.

As shown in step 404, the basalt powder may be treated using a wet method. For instance, methacryloxy functional trimethoxy silane may be diluted in demineralized water and stirred. The basalt powder may be added to the methacryloxy functional trimethoxy silane solution and mixed. In one embodiment, the methacryloxy functional trimethoxy silane may be present in the solution in an amount in a range between 1% and 2% by weight. The basalt powder in methacryloxy functional trimethoxy silane solution may be placed in a drier for 24 hours to 48 hours at a temperature in a range from around 80° C. to around 100° C.

In accordance with step 406, the treated basalt powder may be combined with HDPE in powder form to form a combined compound. In one implementation, the treated basalt powder may be mixed with HDPE powder in a range from about 5% to about 25% by weight. To combine the treated basalt powder with the HDPE powder, a mechanical mixer such as a Cooperon SKZ 26, twin screw extruder may be used.

Referring to step 408 in FIG. 4, the HDPE powder and treated basalt powder mixture are compounded to form a polymer blend (“Polymer Blend”). In some embodiments, primary and secondary antioxidant additives may be added to the Polymer Blend for environmental stability.

In step 410, the Polymer Blend may be extruded. In one embodiment, the following conditions may be used:
Temperature profile from 180° C. to 215° C.
Feed rate 13 kg/h,
Screw speed 370 rpm,
Melt Pressure in the range from 40 bars to 50 bars.
Melt temperature in the range of 210° C. to 232° C.

In step 412, the extruded strands of the Polymer Blend may be cooled. For instance, the extruded strands may be cooled using a water-cooling bath.

In step 414, the cooled extruded strands may be pelletized into granules. In some implementations, granules may be obtained having a diameter in a range from around 3 mm to around 5 mm.

In another embodiment, the Polymer Blend may be used to form non-pressure pipes. In some embodiments of the present invention, the Polymer Blend may be converted into a non-pressure pipe such as a corrugated pipe. The resulting corrugated pipes made in accordance with methods of the present invention may be single or double corrugated polyethylene pipes.

### EXAMPLES

In accordance with method 400, Polymer Blends were prepared comprising HDPE compounds having 10% by weight treated basalt powder and HDPE compounds having 20% by weight treated basalt powder. As a comparative sample, a neat HDPE compound comprising 0% by weight treated basalt powder was prepared. Tests were conducted on these samples with regard to physical, mechanical, thermal, and environmental and chemical resistance properties.

By adding basalt powder to the HDPE matrix as described above, the resulting Polymer Blend's Melt Flow Rate (MFR) was reduced, and density was inversely raised. The reduction in MFR was due to solid particles of basalt powder in the solution combining with the HDPE to form a sort of slurry. The increased density was due to the high density of basalt powder which has an average of 2.99 g/cm3 compared to polyethylene with a density of around 0.955 g/cm3. The flexural strength and flexural modulus of these samples were evaluated. The flexural strength increased from 25 MPa for the sample with 0% basalt powder to 26 MPa and 28 MPa for the samples with 10% and 20% basalt powder respectively, as shown in Table 2.

TABLE 2
Test Results of Flexural Strength

| | | HDPE + | HDPE + | HDPE + |
|---|---|---|---|---|
| Property | Test Method | 0% Basalt | 10% Basalt | 20% Basalt |
| Basalt (%) | ASTM D-5630 | 0 | 9.5 | 19.4 |
| Flexural | ISO 178 | 25 | 26 | 28 |
| Strength [MPa] | | | | |
| Flexural | ISO 178 | 1200 | 1390 | 1530 |
| Modulus [MPa] | | | | |

Utilizing the results illustrated in Table 2, the test samples were evaluated with regard to pipe ring stiffness. Flexural modulus is one of the main property indicators of pipe ring stiffness, as shown in Equation 1 below.

$$S = EI / {D}^{3} \qquad Equation 1$$

In equation 1, E is a modulus of elasticity [kN/m²], I is an inertia of longitudinal pipe (per meter) [m⁴/m], and D is pipe diameter [m]. As can be seen inequation 1, the elastic modulus of plastic composite pipe and pipe ring stiffness S are proportional to the cube of the pipe diameter. When adding between 10% and 20% by weight of basalt powder to the HDPE, it was found that the flexural modulus was raised, when compared to neat HDPE, from 1200 MPa to 1390 MPa and 1530 MPa respectively as illustrated in Table 3. The flexural modulus of 1530 MPa exceeds SN8 and up to approximately 11 kN/m² [SN11].

TABLE 3
Test Results of Ring Stiffness

| | HDPE + | HDPE + | HDPE + |
|---|---|---|---|
| Mechanical Property | 0% Basalt | 10% Basalt | 20% Basalt |
| Flexural Modulus [MPa] | 1200 | 1390 | 1530 |
| Ring Stiffness [KN/m2] | 8 | 10 | 11 |

Additionally, the samples were tested with regard to the effect of treated basalt powder content on physical, mechanical, and thermal tests. The results of these tests are shown in Table 4. Crystallization temperatures of the basalt compound show an increase as basalt content increases as shown in Table 4 and the graph illustrated in FIG. 2. As can be seen in FIG. 2, the enthalpy of crystallization of the basalt compound decreased with increasing basalt powder content. This decrease in enthalpy is likely due to the basalt thermal property, i.e., less energy is needed to crystallize the compound with higher basalt filler.

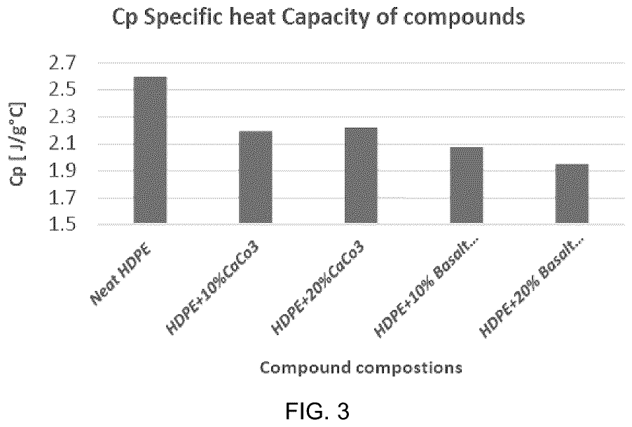

In addition, samples of HDPE comprising 10% by weight calcium carbonate and HDPE comprising 20% by weight calcium carbonate were tested. These samples were tested and evaluated regarding the property of specific heat. The specific heat capacity indicates the amount of heat per unit mass the material can absorb for a temperature change of 1° C. Values of specific heat capacity, Cp, can be seen in Table 6 and FIG. 3 comparing neat HDPE (without treated basalt powder), market standard HDPE plus calcium carbonate, and basalt compounds.

TABLE 4
Physical, Mechanical, and Thermal Test
Results of HDPE Compound Samples

| | | | HDPE + | HDPE + |
|---|---|---|---|---|
| | | | 10% | 20% |
| | | Neat | Basalt | Basalt |
| Property | Standard | HDPE | Powder | Powder |
| MFR g/10 min | ISO 1133 | 1.07 | 1.02 | 0.9 |
| [5 Kg/190° C.] | | | | |
| MassDensity | ISO 1183 | 0.958 | 1.025 | 1.100 |
| (23° C.)[g/cm³] | | | | |
| Ash Content [%] | ASMT D-5630 | 0 | 9.5 | 19.4 |
| Charpy Impact | ISO 179/1eA | 6.42 | 6.42 | 5.98 |
| Strength @ 23° C. | | | | |
| [kL/m2] | | | | |
| Yield Stress | ISO 527-1, -2 | 27.7 | 26.1 | 24.3 |
| [MPa] | | | | |
| Yield Strain [%] | ISO 527-1, -2 | 8.5 | 7.9 | 6.8 |
| Break Strength | ISO 527-1, -2 | 14.8 | 13.4 | 19.7 |
| [MPa] | | | | |
| Crystallization | ISO 11357-1/3 | 112 | 113 | 115 |
| Temperature [° C.] | | | | |
| Enthalpy of | ISO 11357-1/3 | 205 | 184 | 164 |
| Crystallization | | | | |
| [J/g] | | | | |
| Enthalpy of | ISO 11357-1/3 | 197 | 180 | 157 |
| Melting [J/g] | | | | |
| Melting | ISO 11357-1/3 | 137 | 137 | 135 |
| Temperature[° C.] | | | | |

TABLE 5
Thermal Conductivity of the Melt HDPE Compound Samples

| Material | Unit | Result |
|---|---|---|
| HDPE + 10% CaCo3 | W/m*K | .2430 |
| HDPE + 20% CaCo3 | W/m*K | .2540 |
| HDPE + 10% BasaltPowder | W/m*K | .2400 |
| HDPE + 20% BasaltPowder | W/m*K | .2500 |

TABLE 6
Specific Heat Capacity of the HDPE Compound Samples

| Material | Unit | Result |
|---|---|---|
| NeatHDPE | J/g*° C. | 2.596 |
| HDPE + 10% CaCo3 | J/g*° C. | 2.190 |
| HDPE + 20% CaCo3 | J/g*° C. | 2.219 |
| HDPE + 10% BasaltPowder | J/g*° C. | 2.071 |
| HDPE + 20% BasaltPowder | J/g*° C. | 1.946 |

$$Cp = Q / m Δ T \qquad Equation 2$$

In Equation 2, Cp is the quantity of heat, expressed in J/Kg° C., m is the mass of material expressed in Kg, ΔT is temperature change in ° C. The cooling gradients illustrated in FIG. 3 show that neat HDPE without any filler has the highest Cp value, and, in turn, the lowest cooling rate. When adding successively 10% and 20% of treated basalt powder, the cooling time is shortened significantly. Moreover, the HDPE compounds with treated basalt powder had shorter cooling times as compared to HDPE compounds with calcium carbonate or to neat HDPE material. Shortening the cooling rate of the HDPE compounds would lead to an increase in the production line speed of HDPE products. Therefore, in comparison to HDPE compositions comprising calcium carbonate fillers, the present compositions exhibit superior mechanical and thermal properties in the production and use of non-pressure pipes.

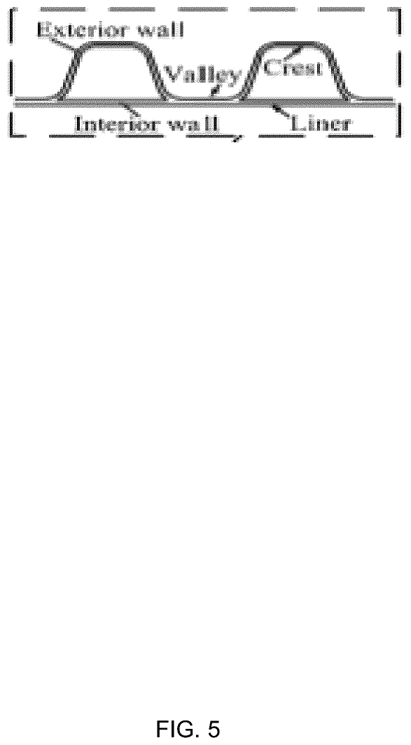

Corrugated pipes comprising compounds with HDPE without filler, HDPE with calcium carbonate filler, and HDPE with basalt powder filler were tested regarding heat transfer. The temperature of corrugated pipe was measured while exiting the corrugator and at defined points during the corrugation process. FIG. 5 of the Drawings depicts a cross-sectional view of an illustrative corrugated pipe with crest and valley positions. These temperatures were recorded at crest and valley positions of the corrugated pipe for all three compounds (neat HDPE), HDPE with 20% CaCO₃, and HDPE with 20% basalt powder. These values are reported in Table 7.

TABLE 7
Profile Temperature Recorded during Corrugated Pipe Extrusion

| | Temperature ° C. | Temperature ° C. |
|---|---|---|
| Material | of Crest | of Valley |
| Neat HDPE | 55 | 40 |
| HDPE + 20% CaCO₃ | 45 | 35 |
| HDPE + 20% Basalt Powder | 37 | 26 |

The data displayed in Table 7 shows significant differences between HDPE with basalt powder filler, HDPE with CaCO₃ filler, and neat HDPE material. These temperature deviations confirm that HDPE compound with basalt filler has a higher heat transfer, i.e., can release heat faster and thus cooling faster in comparison to the CaCO₃ compound and neat material. Subsequently, the line speed during manufacture can be increased.

From the above description, it is clear that the inventive concept(s) disclosed herein are well adapted to carry out the objects and to attain the advantages mentioned herein, as well as those inherent in the inventive concept(s) disclosed herein. While the implementations of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A polymer blend, comprising:
high density polyethylene (“HDPE”); and
basalt powder coated with methacryloxy functional trimethoxy silane.

2. The polymer blend of claim 1, having a ratio of basalt powder to HDPE in a range from about 1:20 to about 1:4.

3. The polymer blend of claim 1, wherein the basalt powder is present in an amount in a range of from about 5% to about 25% by weight of the polymer blend.

4. The polymer blend of claim 1, wherein the HDPE has a melt flow ratio (MFR) in a range of about 0.20 g/10 min. to about 2.5 g/10 min at 5 kg and a temperature of 190° C.

5. The polymer blend of claim 1, wherein the HDPE has a density in a range of about 0.950 g/cm³ to about 0.960 g/cm³.

6. The polymer blend of claim 1, wherein the HDPE comprises a trimodal 1-butene copolymer.

7. The polymer blend of claim 1, further comprising an antioxidant.

8. The polymer blend of claim 1, wherein basalt powder is coated with about 1% of methacryloxy functional trimethoxy silane using a method comprising:
diluting the methacryloxy functional trimethoxy silane in demineralized water;
mixing the basalt powder and the diluted methacryloxy functional trimethoxy silane; and
drying the basalt powder and methacryloxy functional trimethoxy silane mixture to obtain a coated basalt powder.

9. A method of making a polymer blend, comprising the steps of:
diluting methacryloxy functional trimethoxy silane in water;
mixing basalt powder and the diluted methacryloxy functional trimethoxy silane;
drying the basalt powder and methacryloxy functional trimethoxy silane mixture to obtain a coated basalt powder; and
combining the coated basalt powder with high density polyethylene (“HDPE”) to obtain a polymer blend.

10. The method of making the polymer blend of claim 9, wherein the methacryloxy functional trimethoxy silane is present in the coated basalt powder in an amount in a range of about 1% to 2% by weight.

11. The method of making the polymer blend of claim 9 wherein the coated basalt powder is present in the polymer blend in an amount in a range of from about 5% to about 25% by weight.

12. The method of making the polymer blend of claim 9, further comprising a step of extruding the polymer blend.

13. The method of making the polymer blend of claim 12, further comprising a step of pelletizing the extruded polymer blend to obtain a polymer blend pellet.

14. The method of making the polymer blend of claim 13, further comprising a step of converting the polymer blend pellet into a non-pressure polyethylene pipe.

15. The method of making a polymer blend of claim 14, wherein the non-pressure polyethylene pipe is corrugated.

16. The method of making a polymer blend of claim 9, wherein the HDPE powder comprises a trimodal 1-butene copolymer.

17. A method of producing a non-pressure polyethylene pipe, comprising the steps:
coating basalt powder with methacryloxy functional trimethoxy silane to obtain a coated basalt powder;
extruding the coated basalt powder and high-density polyethylene (“HDPE”) powder into a polymer blend; and
converting the polymer blend into a non-pressure polyethylene pipe.

18. The method of producing the non-pressure polyethylene pipe of claim 17, wherein the methacryloxy functional trimethoxy silane is present in the coated basalt powder in an amount in a range of about 1% to about 2% by weight.

19. The method of producing the non-pressure polyethylene pipe of claim 17, wherein the coated basalt powder is present in the polymer blend in an amount in a range of from about 10% by weight to about 25% by weight.

20. The method of producing the non-pressure polyethylene pipe of claim 17, further comprising a step of pelletizing the polymer blend, prior to converting the polymer blend into a a non-pressure polyethylene pipe.
